(19) United States
(12) Patent Application Publication
(10) Pub. No.: US 2002/0093564 A1
(43) Pub. Date: Jul. 18, 2002

(54) Digital camera network for commercial aircraft

(76) Inventor: Danny Israel, Kobenhavn (DK)

Correspondence Address: THE WINARSKI FIRM, P.L.L.C., 1265 EAST UNIVERSITY DRIVE, SUITE 3015, TEMPE, AZ, 85281, US

(21) Appl. No.: 09/760,127

(22) Filed: Jan. 12, 2001

(51) Int. Cl. H04N 7/18

(52) U.S. Cl. 348/145; 348/144; 348/143; 348/153; 348/159; 345/700; 345/719

(57) ABSTRACT

An aircraft camera system is described for passenger entertainment and safety that includes several arrays of digital cameras mounted on a passenger aircraft. These arrays of digital cameras, which include a top camera array, a bottom camera array, and two side camera arrays, are connected to and controlled by a central computer system. These arrays of digital cameras are positioned to view the wings, tail section, engines, and flaps on the aircraft as well as views of the horizon and ground. The passengers can access the views gathered by these multiple cameras for entertainment on their personal liquid crystal display screens, mounted in the rear back portion of each passenger seat. The crew can access the views gathered by these multiple cameras to check on the integrity of the aircraft. Also, in an emergency, the flight crew can restrict camera access to the passengers, to prevent panic.

### FIELD OF THE INVENTION

The present invention relates to the field of camera viewing systems for commercial aircraft. More specifically, the present invention relates to a system of digital cameras operated by a central computer to enhance pilot visibility both in the air and while on the runway, permit observation of aircraft status during flight, and provide in-flight passenger entertainment.

### BACKGROUND

To safely fly an aircraft, a pilot must have full knowledge about the condition of the aircraft. It is not uncommon for damage to occur to the aircraft during flight. During one such flight, the Concorde supersonic passenger aircraft experienced a punctured fuel tank due to a burst tire. The fuel began to leak out of the top of one of the wings. A passenger saw the damage and immediately called for a flight attendant. Due to the fact that the pilots did not have an onboard camera to view the state of the wings, the pilot had to walk back into the passenger cabin to view the damage. At first the pilot could not see the damage. It was not until the passenger shoved the pilot's head against the window that the damage became visible. Fortunately, on this flight, the pilots safely returned the Concorde and its passengers to the airport. If the passenger had not seen the damage and altered the crew, the outcome could have turned out far worse.

In addition to the above problem experienced by the Concorde, aircraft can incur various other types of damage during flight. Impacts with birds can damage engines or the rear tail section and stabilizers. Icing conditions can lead to aircraft stalling. Poor maintenance and worn parts have caused engines to fall off during flight. Alaska Airlines experienced a jammed stabilizer that the pilots attempted to compensate for, rather than land. Had the pilots known the extent of the actual problem, they could have landed immediately. Microscopic cracks in the fuselage have caused gaping holes to burst in the aircraft passenger cabin during the pressurized conditions of high altitude flight. These are all forms of aircraft damage that a pilot needs immediate and accurate information of, in order to safely fly the aircraft to an airport.

To successfully deal with damage incurred by the aircraft, it is necessary that the pilot have as much knowledge as possible about the state of the aircraft. One method of providing as much information as possible to the pilot is through an on-board camera viewing system. Through placing various cameras around the aircraft, it is possible to enhance the pilot visibility, allowing the pilot to acquire an accurate understand of the condition of the aircraft.

Aside from safety, there is another highly beneficial use for an on-board camera system. One of the most popular activities on an aircraft is to look out the window. Unfortunately, generally only the passengers seated right next to the window can really enjoy the view. Further, even the passenger with the window seat can only see what is out his window. Typically, most new commercial passenger aircraft include liquid crystal viewing screens in the backs of passenger seats for entertainment. Through linking the on-board camera system to these passenger viewing screens, all passengers can enjoy the views from these cameras.

At present, there are several on-board camera systems known to the art that are used for passenger safety and entertainment. One such system is disclosed in a patent issued to Masterfield, U.S. Pat. No. 4,041,529, entitled “Airplane Route Viewing System,” issued Sep. 9, 1997. The patent issued to Masterfield teaches an entertainment system for presenting to the airplane passengers, over a television viewing monitor screen, a photographic display of a section of the route viewed by a television camera mounted in the nose of the airplane. First, this patent teaches the use of a single camera mounted in the nose of the aircraft. Second, this patent describes a process of presenting images from a television camera directly over a television screen in conjunction with prerecorded messages stored on tape. It is important to note that the system described by this patent does not teach the use of a central computer to control an array of digital cameras.

Another aircraft camera systems is described in Lee, U.S. Pat. No. 5,742,336, entitled “Aircraft Surveillance and Recording System,” issued Apr. 21, 1998. This patent, issued to Lee, essentially teaches a modernized version of an aircraft “blackbox.” This patent discloses a system of video cameras that include an audio capability to record the flight of an aircraft. The images taken by these cameras are broadcast to a receiving station on the ground where they are recorded. Therefore, in the event of a crash, the crash investigators would have in flight video of what occurred. The views taken by these cameras are not shown in flight to either the passengers or the crew. Therefore, this system does not enhance the visibility of the pilots or provide entertainment to passengers. Also, this patent teaches that three of the camera views are of the interior of the aircraft, namely the pilots, the cockpit, and the passenger cabin. Therefore, in the event of a crash, the cameras would record the actions of terrified passengers or pilots asleep at the controls. The pictures taken by these cameras would not help either the crew or the passengers in a flight. However, the images taken by these cameras would help trial lawyers seeking jury verdicts after an airline crash. As with the Masterfield patent, this patent does not teach the use of a central computer to control passenger or crew interaction with a plurality of digital cameras.

### SUMMARY OF THE INVENTION

The present invention is an aircraft camera system for passenger entertainment and safety. The system includes several arrays of digital cameras mounted on a passenger aircraft. These arrays of digital cameras are connected to and controlled by a central computer system. The passengers can access the views gathered by these multiple cameras for entertainment on their personal liquid crystal display screens mounted in the rear back portion of each passenger seat. Further, these display screens are touch screens allowing passengers to scroll through menus and select the camera angle they wish to view. In addition, using the touch screen display, they can select between hearing audio about the flight or a musical selection. In an alternate embodiment, a passenger can control the screen display using a push button control unit electrically connected to the screen.

The crew can access the views gathered by these multiple cameras to check on the integrity of the aircraft. At times during a flight, damage to the airframe may occur due to midair collisions, burst tires, or other mechanical problems. It then becomes necessary for the flight crew to determine the condition of the aircraft in order to safely land the aircraft. Having direct camera views of critical aircraft systems such as the wings, tail structure, and landing gear would enhance the ability of flight crews to determine the state of their aircraft. Also, in an emergency, the flight crew can restrict camera access to the passengers, to prevent panic.

The camera system includes a top camera array, a bottom camera array, and two side camera arrays. The top camera array has two cameras mounted within an aerodynamic, durable, and transparent housing. The top camera array is mounted on the top of the aircraft fuselage near the front of the aircraft. The first of the two cameras in the top camera array is pointed rearward, to provide a view the tail section of the aircraft. This camera view will allow pilots to view the condition of the rear stabilizers. The second of the two cameras in the top camera array is pointed forward, to provide passengers with an entertaining view of the sky and terrain that the aircraft is flying toward.

The bottom camera array has five separate digital cameras mounted within an aerodynamic, durable, and transparent housing. The bottom camera array is mounted on the bottom of the aircraft fuselage forward of the wings and rear of the nose landing gear. The front camera in the bottom array is pointed forward, to provide the passengers with an entertaining view of the sky and terrain ahead of the aircraft. Further, this camera would provide an exciting view of the airport and runway during take-off and landing. The second camera in the bottom array is pointed down, to provide passengers with a view of the land or sea beneath the aircraft during flight. The third camera in the bottom camera array is pointed toward the starboard wing, flaps, and engines. The fourth camera in the bottom array provides a view of the port wing, flaps, and engines. These two cameras thereby provide the pilot and crew with information about the state of the wing, flaps, and engines. The last camera in the bottom array is pointed aft, providing a view of the sky and terrain that the aircraft is flying away from. This aft view would provide exciting images as the aircraft takes off, to begin its flight.

The two side camera arrays are each comprised of a single camera pointed over the wing to give the crew information about the condition of the wings and flaps. The two side cameras are mounted within the passenger cabin and are pointed out to view through existing passenger windows.

The cameras used in the three camera arrays are preferably digital cameras. The cameras can be mounted such that they can be moved to change the camera's viewing orientation. In addition, it is desirable that the camera lens have the ability to zoom in or provide more of a wide-angle view. The zoom function and wide-angle function are currently available on many quality digital cameras and would be advantageous for viewing critical aircraft areas such as engines, wheels, or control surfaces.

A central computer controls the plurality of camera arrays and interconnects them to the passenger and crew viewing screens. The viewing screens are preferably touch screens, so that the passengers and crew can select various viewing choices directly on the screen.

The primary object of the invention is to enhance passenger safety by increasing the ability of the pilot and crew to determine the state of the aircraft. A further object of the invention is to provide passenger entertainment. A still further object of the invention is to provide a digital camera system that would require a minimum amount of modification to a current aircraft for use. A further object of the invention is to provide a digital camera system that integrates with a central computer to allow for ease of use by the crew and passengers.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 is a block diagram of the camera viewing system;

FIG. 2 shows an exterior view of a 737 aircraft and the placement of the various cameras comprising the camera viewing system;

FIG. 3 shows a top view of the bottom camera array;

FIG. 4 shows a top view of the top camera array;

FIG. 5 shows a perspective view of the top camera array mounted to the top part of an aircraft fuselage;

FIG. 6 shows a perspective view of the bottom camera array mounted to the bottom part of an aircraft fuselage;

FIG. 7 shows a perspective view of one of the side camera arrays mounted in the interior of the aircraft passenger cabin just above the leading edge of the wing;

FIG. 8 shows a perspective view of one of the side camera arrays mounted in a protective container;

FIG. 9 shows a passenger viewing screen displaying the output from one of the cameras located on the bottom camera array;

FIG. 10 shows a typical row of airline passenger seats having viewing screens mounted in the rear of the seat backs;

FIG. 11 shows a top view of a 737 aircraft along with the areas within the view of the top and side camera arrays;

FIG. 12 shows a bottom view of a 737 aircraft along with the areas within the view of the bottom camera array;

FIG. 13 shows the menu selection available to the crew of the aircraft for operating the camera viewing system; and

FIG. 14 shows the menu selection available to passengers for operating the camera viewing system.

### DESCRIPTION OF THE PREFERRED EMBODIMENTS

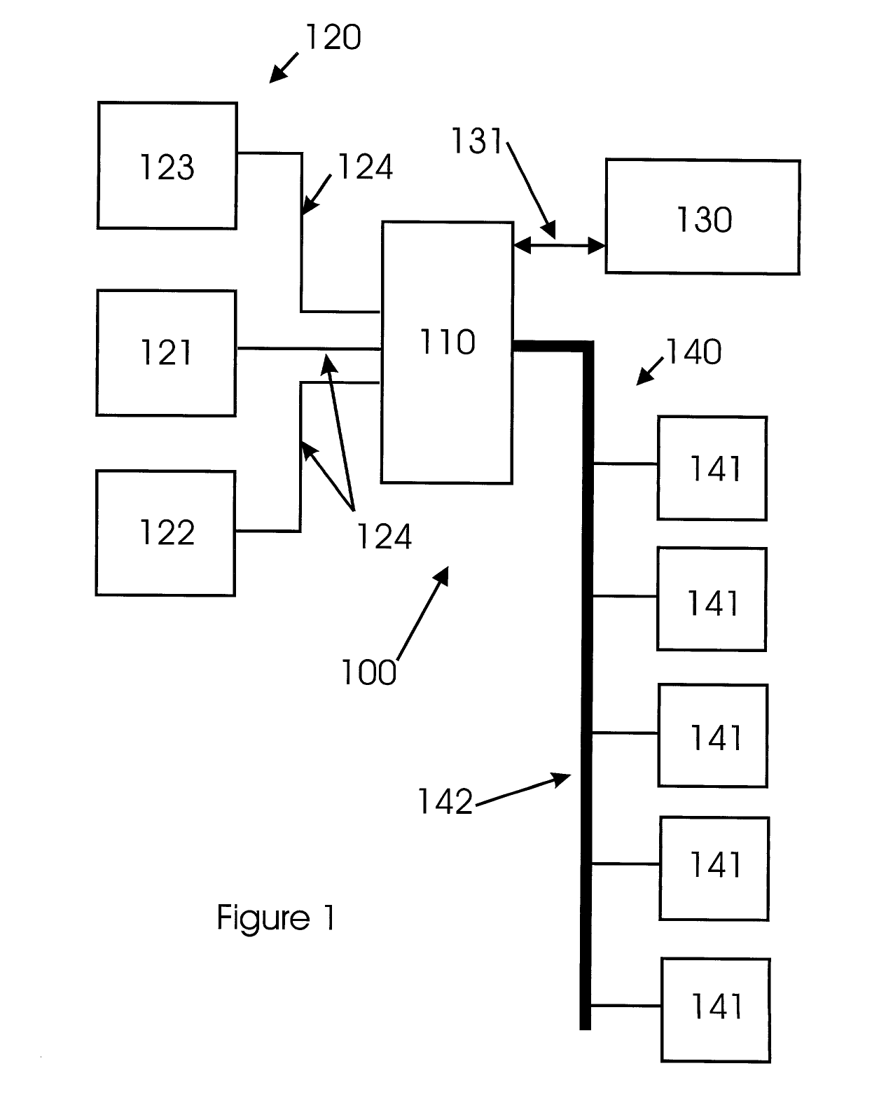

Referring to the Figures by characters of reference, FIG. 1 discloses a block diagram of the aircraft camera viewing system 100. The aircraft camera viewing system 100 is comprised of a camera system 120 that has three separate camera arrays 121, 122, and 123. The separate camera arrays are the top camera array 121, bottom camera array 122, and side camera array 123. These three camera arrays 121, 122, and 123 are connected to a central computer 110 via three separate busses 124. Bus 124 may be made of copper wire or fiber-optic cable. Fiber-optic cable is immune to radio frequency interference (RFI), which may have advantages to maintaining the clarity of images. The central computer 110 is connected to a pilot display 130 in the cockpit. The central computer 110 is also connected to a passenger viewing screen array 140. The passenger viewing screen array 140 is comprised of a series of liquid crystal viewing screens or displays 141 connected to a central bus 142. Similar to bus 124, bus 142 may also be made of copper wire or fiber-optic cable. The aircraft crew in the cockpit can interconnect via bi-directional communications line 131 with the central computer 110 and lockout the passengers from viewing the camera array 120. In the event of aircraft damage, views of the damaged aircraft on the passenger viewing display 141 could cause passenger panic. However, the crew can prevent this panic by disabling the ability of the passengers to view the camera array 120.

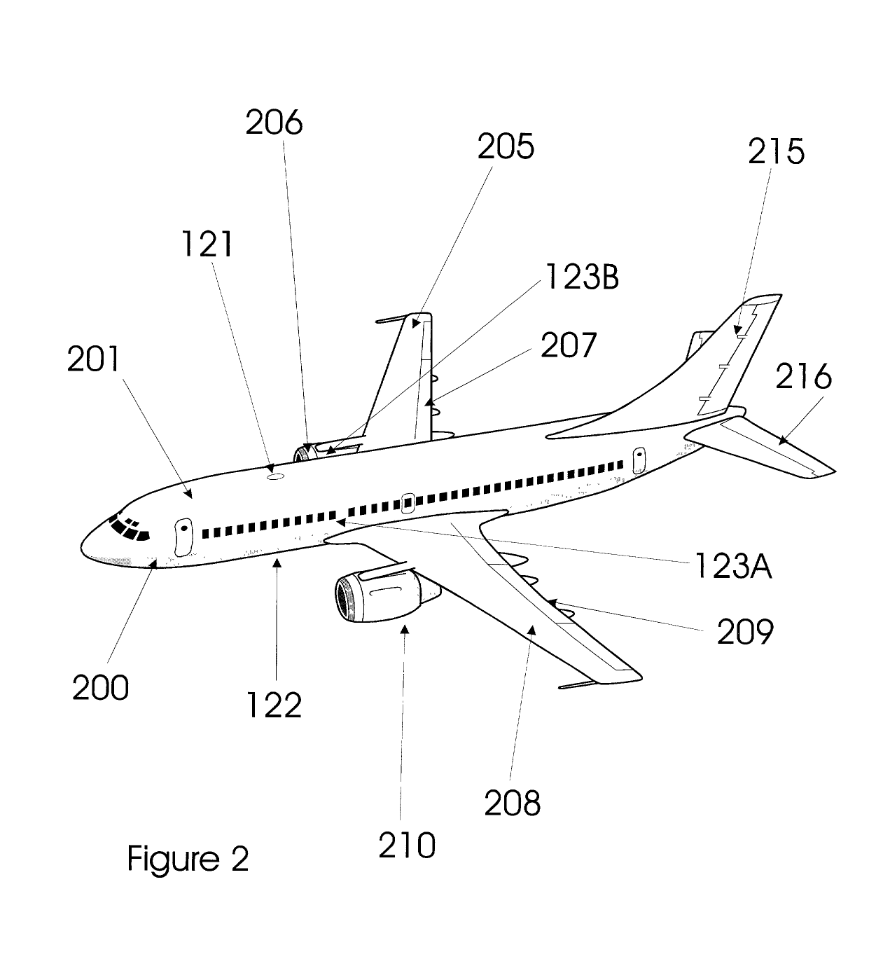

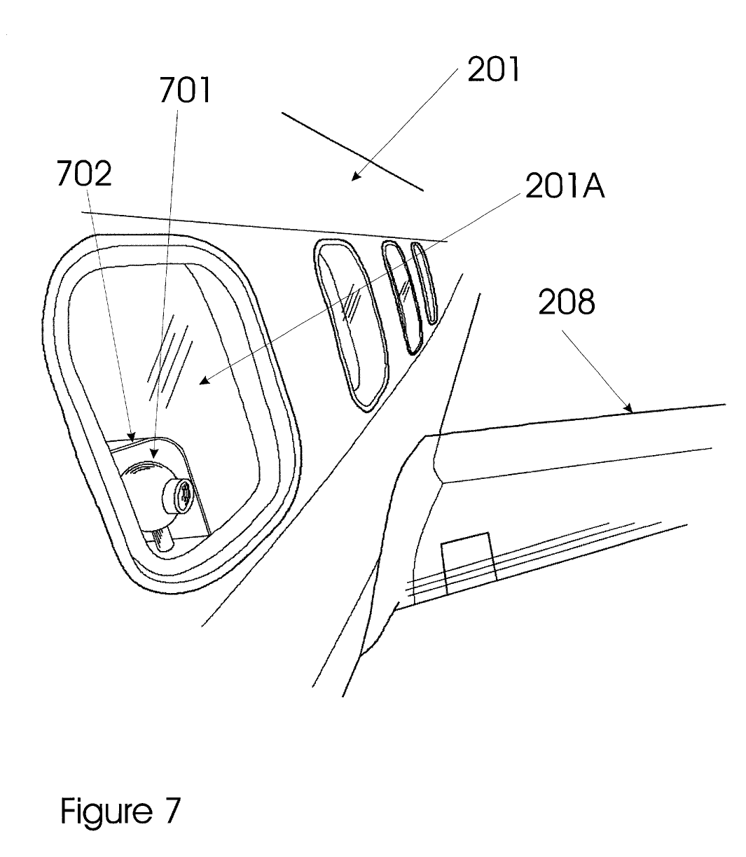

FIG. 2 shows a perspective view of a Boeing 737 passenger aircraft 200 having a generally tubular-shaped fuselage 201. As shown in FIG. 2, the top camera array 121 is mounted on the top of the aircraft fuselage 201. The bottom camera array 122 is mounted on the bottom of the aircraft fuselage 201. Both of the top and bottom camera arrays 121 and 122 are mounted on the exterior of the aircraft 200. The side camera array 123 is actually comprised of two separate cameras 123A and 123B mounted on each side of the aircraft 200, such as shown in FIG. 7. The starboard camera array 123B is preferably mounted within the passenger cabin on the starboard side of the aircraft 200. The port camera array 123A is preferably mounted within the passenger cabin on the port side of the aircraft 200. However, said cameras 123A and 123B could alternately be attached to the fuselage 201. The side camera arrays 123A and 123B are aimed along the leading edge of the wing to provide a good view of the wings 205 and 208 and engines 206 and 210. While the camera system 120 is shown mounted on a Boeing 737, this system can integrate with other Boeing aircraft, Airbus aircraft, or aircraft of other manufacturers, in a similar manner. Boeing aircraft models 707, 747, 757, 767, and 777 and all Airbus aircraft have designs similar to the 737 in that all of the engines are mounted under the wings. Therefore, the position of the various camera arrays 121, 122, 123A and 123B in FIG. 2 would also view the wings, engines, and other critical components in these other aircraft.

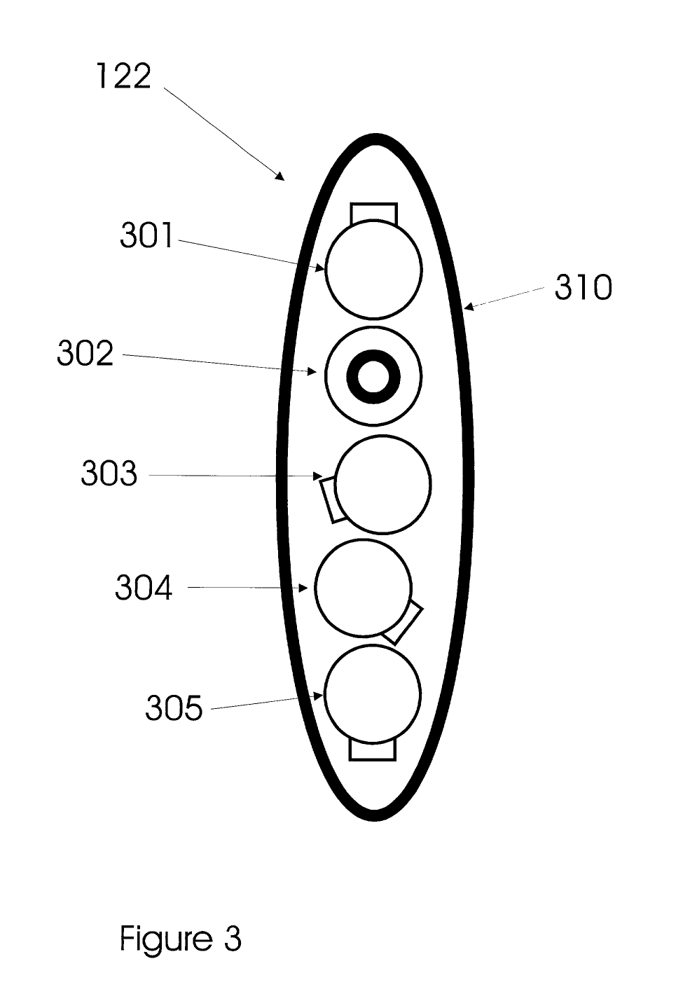

The bottom camera array 122 is shown in FIG. 3. The bottom camera array 122 is enclosed within an aerodynamic, durable, and transparent housing 310. Preferably, the transparent housing 310 is made of polymethyl methacrylate, which is commonly known as Plexiglas or Lucite. However, other transparent housing materials could be used for housing 310, such as hardened glass, acrylic, cellulose acetate butyrate, or polystyrene.

The bottom camera array 122 is comprised of five separate cameras 301-305. The front bottom camera 301 in the bottom array 122 is pointed forward to provide the passengers with an entertaining view of the sky and terrain ahead of the aircraft 200. Further, this camera would provide an exciting view of the airport and runway during take-off and landing. The second camera 302 in the bottom array 122 is pointed down to provide passengers with a view of the land or sea beneath the aircraft 200 during flight. The third camera 303 in the bottom camera array 122 is pointed toward the starboard wing 205, flaps 207, and engine 206. The fourth camera 304 in the bottom array 122 provides a view of the port wing 208, flaps 209, and engine 210. These two cameras 303 and 304 thereby provide the pilot and crew with information about the state of the wings 205 and 208, flaps 207 and 209, and engines 206 and 210. The last camera 305 in the bottom array 122 is pointed aft providing a view of the sky and terrain that the aircraft 200 is flying away from. This aft view would provide exciting images as the aircraft 200 takes off, to begin its flight. It is important to note that during the construction of the bottom camera array 122, the various cameras 301-305 can be positioned at different angles in order to integrate with aircraft models other than the Boeing 737.

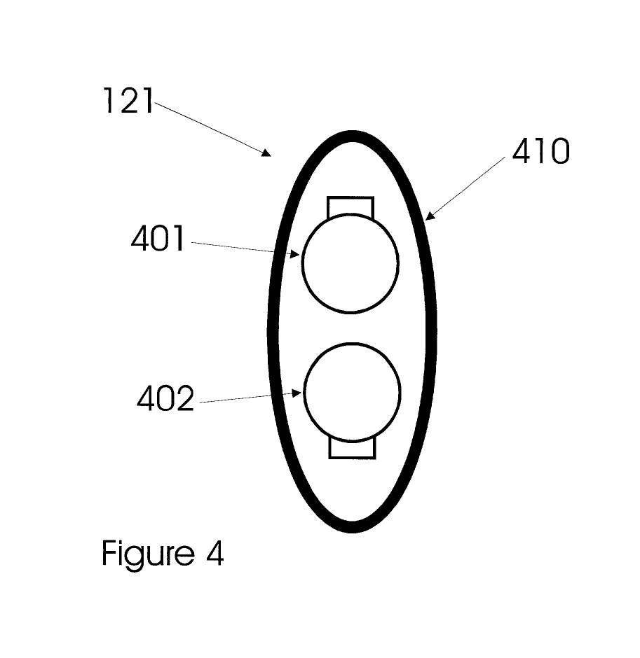

FIG. 4 shows the top camera array 121. The top camera array 121 has two cameras 401 and 402 mounted within an aerodynamic, durable, and transparent housing 410. As with housing 310, the preferred material for housing 410 is polymethyl methacrylate, with alternate materials including hardened glass, acrylic, cellulose acetate butyrate, or polystyrene. The top camera array 121 is mounted on the top of the aircraft fuselage 201 near the front of the aircraft 200. The first of the two cameras 402 in the top camera array 121 is pointed to view the tail section 215 of the aircraft 200. This camera 402 view will allow pilots to view the condition of the rear stabilizers 216. The second of the two cameras 401 in the top camera array 122 is pointed forward to provide passengers with an entertaining view of the sky and terrain that the aircraft 200 is flying toward.

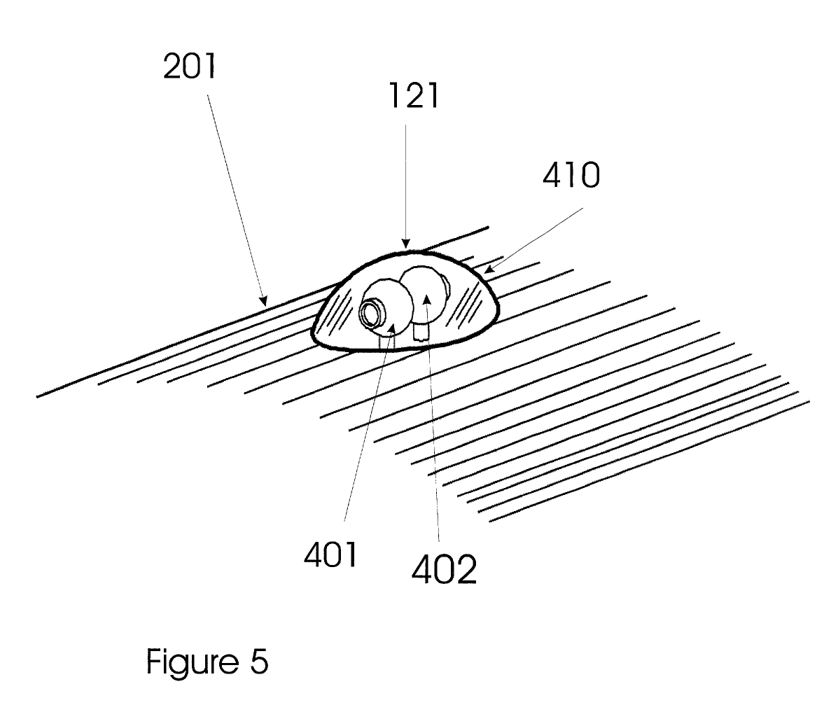

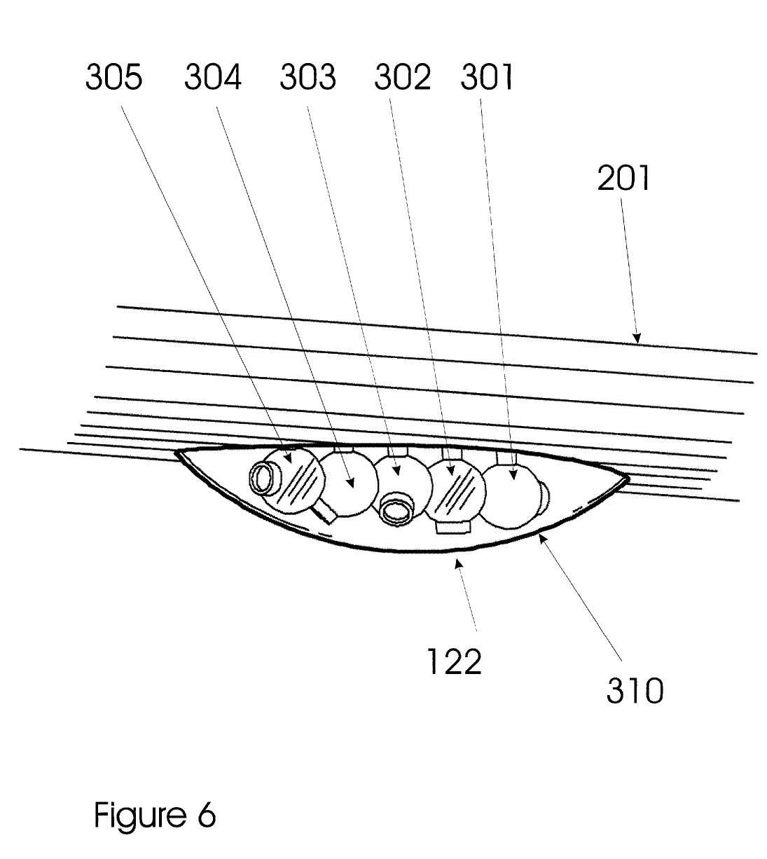

FIGS. 5 and 6 provide a perspective view of the top camera array 121 and bottom camera array 122 mounted to the exterior of the aircraft fuselage 201. As shown, the top and bottom camera arrays 121 and 122 are enclosed by aerodynamic, durable, and transparent housings 410 and 310 respectively.

FIG. 7 shows a perspective view of the port camera array 123A mounted within the passenger cabin 201A of the fuselage 201 above the port wing 208. The port camera array 123A is comprised of a single digital camera 701 mounted within a durable plastic housing 702. The digital camera 701 is angled to provide a view of the entire wing 208 and engine 210. The starboard camera array 123B is identical to the port camera array 123A.

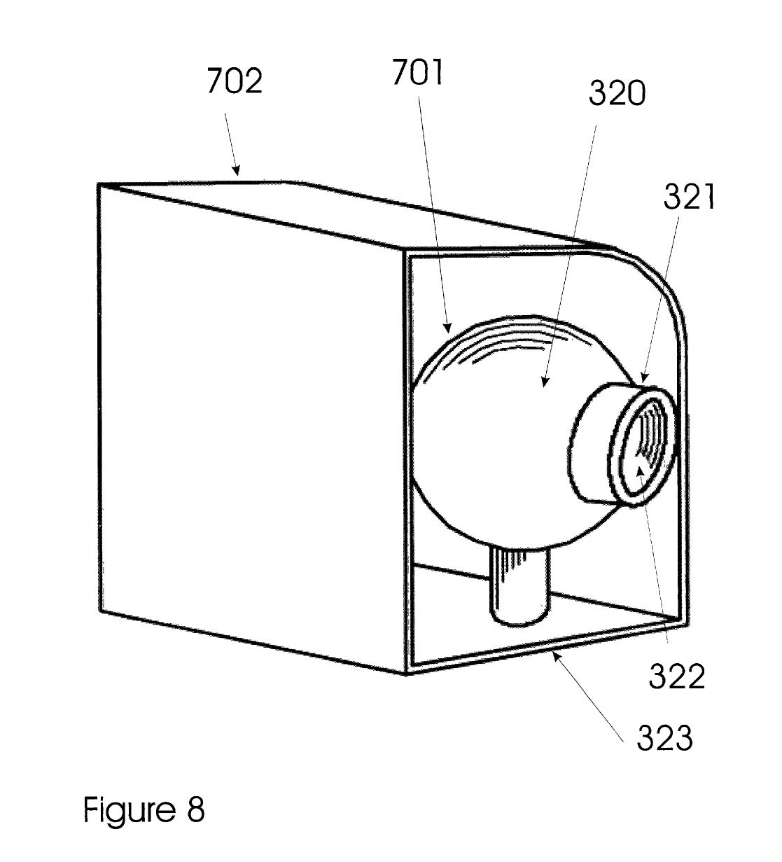

A perspective view of the digital camera 701 and housing 702 is shown in FIG. 8. The digital camera and housing comprising the starboard camera array 123B are identical to the digital camera 701 and housing 702.

The cameras 301-305, 401 and 402, and 701 are preferably digital cameras. The digital cameras are provided with a durable housing 320 having a cylindrical cover 321 holding the lens 322. The digital camera has the ability to manipulate lens 322 in order to zoom in on specific objects, or provide a wide-angle view. The zoom function and wide-angle view function are currently available on many standard digital cameras available in the marketplace. For instance, the SONY ® digital camcorder has a 10× optical and 120× digital zoom feature. This would allow the crew of aircraft 200 to zoom in on key areas of the aircraft 200, or to pursue a wide-angle view. The SONY ® digital camcorder has an IEEE-1394 Firewire interface. Firewire is a high speed interface cable. In a preferred embodiment, cables 124 connecting the camera array 120 to the computer 110 are Firewire cables.

In addition, the SONY ® digital camcorder also has picture stabilization, called STEADYSHOT ®, which would reduce the effect of aircraft vibration on the viewed images. The SONY ® camcorder supports super laserlink wireless transmission. Therefore, in an alternative embodiment, links 124 would be wireless laserlinks, to reduce the need of stringing cables to hard to reach locations. Since digital cameras and camcorders do not use film, they are capable of operating in extremely low-light conditions. Thus, digital photography permits operation in a much wider range of ambient light conditions, which makes digital photography the preferred means of photography for this application. In an alternative embodiment, cameras 301-305, 401 and 402, and 701 have an infra-red capability to enable the pilots to view the aircraft during night time conditions.

Cameras 301-305, 401 and 402, and 701 are mounted on bases 323 that permit the position of the cameras to be altered. This feature allows the camera array 120 to integrate with other models of aircraft.

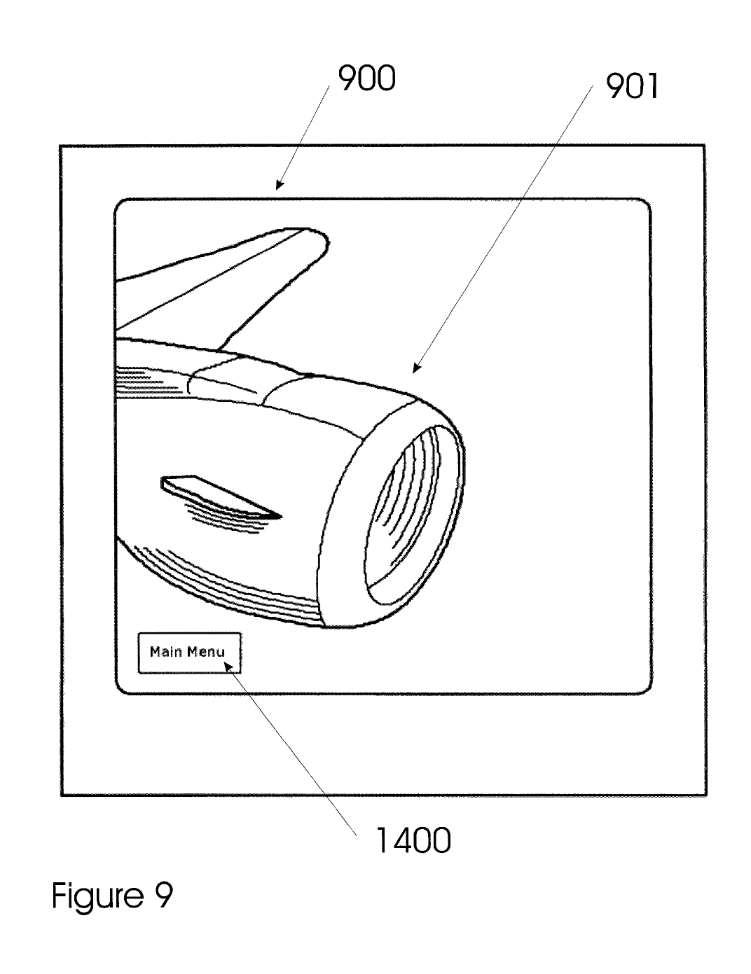

FIG. 9 shows a passenger viewing screen 900 displaying the output from camera 303 located on the bottom camera array 122. The passenger viewing screen 900 is preferably a conventional liquid crystal flat screen display currently in use on many passenger aircraft. An LCD display uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically back lit via fluorescent light. Inside these glass plates is a matrix of electrodes. When an element of the matrix, called a pixel, experiences a voltage change, the polarization of the adjacent liquid crystal molecules change, which alters the light transmitted through the LCD pixel and hence seen by the user. Display 900 could alternatively be a gas-discharge display, which is commonly known as a plasma display. A gas-discharge display contains neon between a horizontal and vertical set of electrodes. When a vertical and a horizontal electrode are charged, the neon glows at their intersection, emitting light. Display 900 may equally be a cathode ray tube (CRT) commonly used with desktop computers, a liquid crystal display, light emitting diode display, or a flat panel electroluminescent display. Display 900 could equally use light emitting diodes (LEDs) which are a semiconductor device that converts electrical energy into light. LEDs work on the principle of electroluminescence and are produce little heat for an amount of light output. Display 900 could be a flat panel electroluminescent display, where a thin phosphor layer is set between vertical and horizontal electrodes. These electrodes form an X-Y Cartesian coordinate system. When a vertical and a horizontal electrode are charged, the phosphor at their intersection emits light.

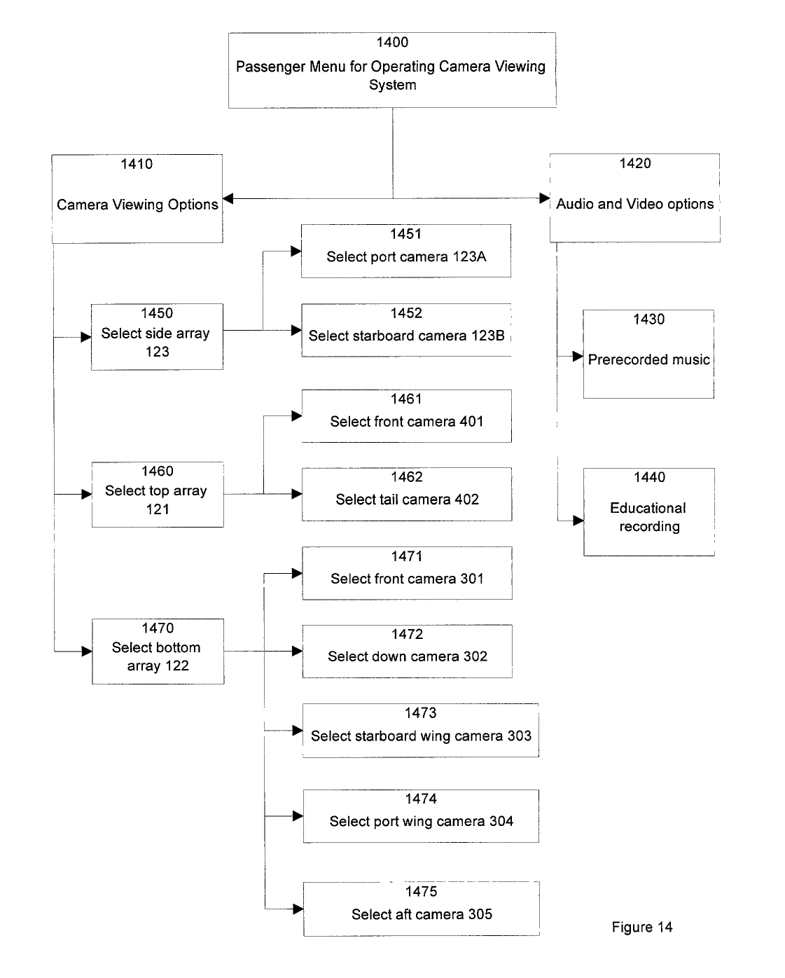

In FIG. 9, two items are displayed on the display 900. The first item is the actual image 901 as seen by camera 303. The second item is a menu selection 1400. The menu section button 1400 allows a passenger to activate the menu choices available to the passenger in the camera system 100. Preferably, the display 900 is a touch screen display such that the passenger can just press the screen at the position marked main menu 1400. The menu 1400 available to the passengers is detailed in FIG. 14. In an alternative embodiment, the passenger can select the choices displayed on display 900 using a push button control device mounted on an armrest of each passenger's seat.

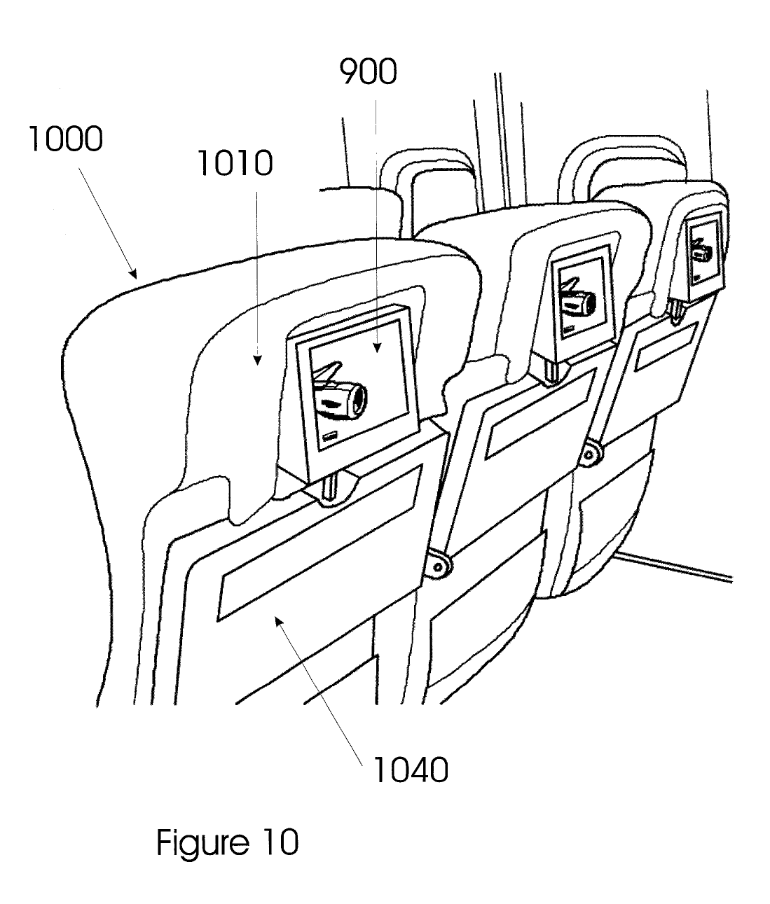

FIG. 10 shows a typical row of airline passenger seats 1000 having viewing screens 900 mounted in the rear of the seat backs 1010. In many commercial aircraft produced today, it is common to have a liquid crystal display mounted in the rear seat back 1010 of a passenger seat 1000. Alternatively, screen 900 may be mounted on the arm rest of the passenger seat 1000. Also visible in FIG. 10 is the meal tray 1040.

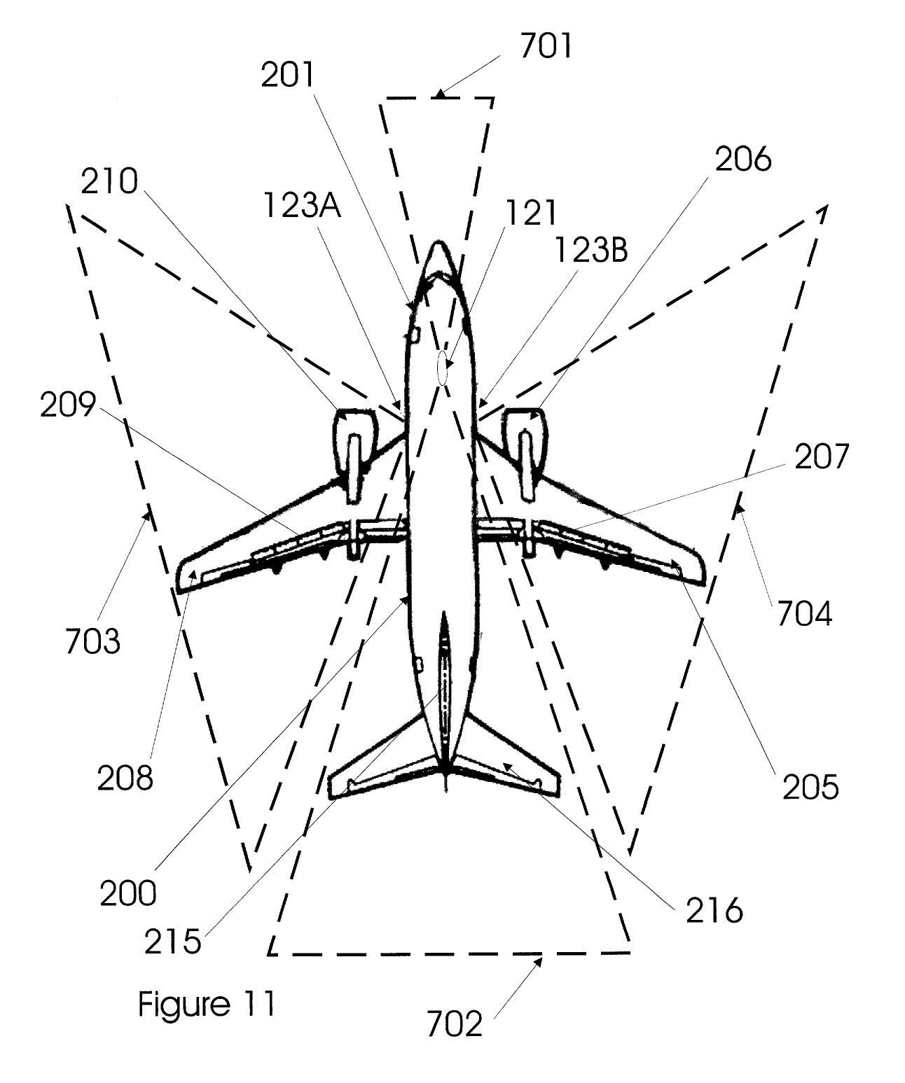

FIG. 11 shows a top view of a 737 aircraft 200 along with the areas within the view of the top and side camera arrays 121 and 123. The top camera array 121 contains two cameras, 401 and 402. Camera 401 is pointed forward and has the viewing area marked by the dashed triangle 701. Note that depending upon the optics used for the lens to camera 401, the viewing area 701 can vary. Camera 402 is pointed to the rear of the aircraft 200 and has the viewing area 702. The side camera array 123 comprised of the port and starboard cameras 123A and 123B cover the viewing areas 703 and 704 respectively. As shown by FIG. 11, the side camera array 123 covers the majority of the wings 205 and 208 and engines 206 and 210. The rear camera 402 covers the rear tail section 215 and stabilizers 216. These camera angles 701, 702, 703, and 704 provided to the crew of the aircraft 200 will greatly enhance the amount of knowledge available to the crew about the state of their aircraft 200 thereby enhancing passenger safety both in the air and on the ground, on airport taxiways.

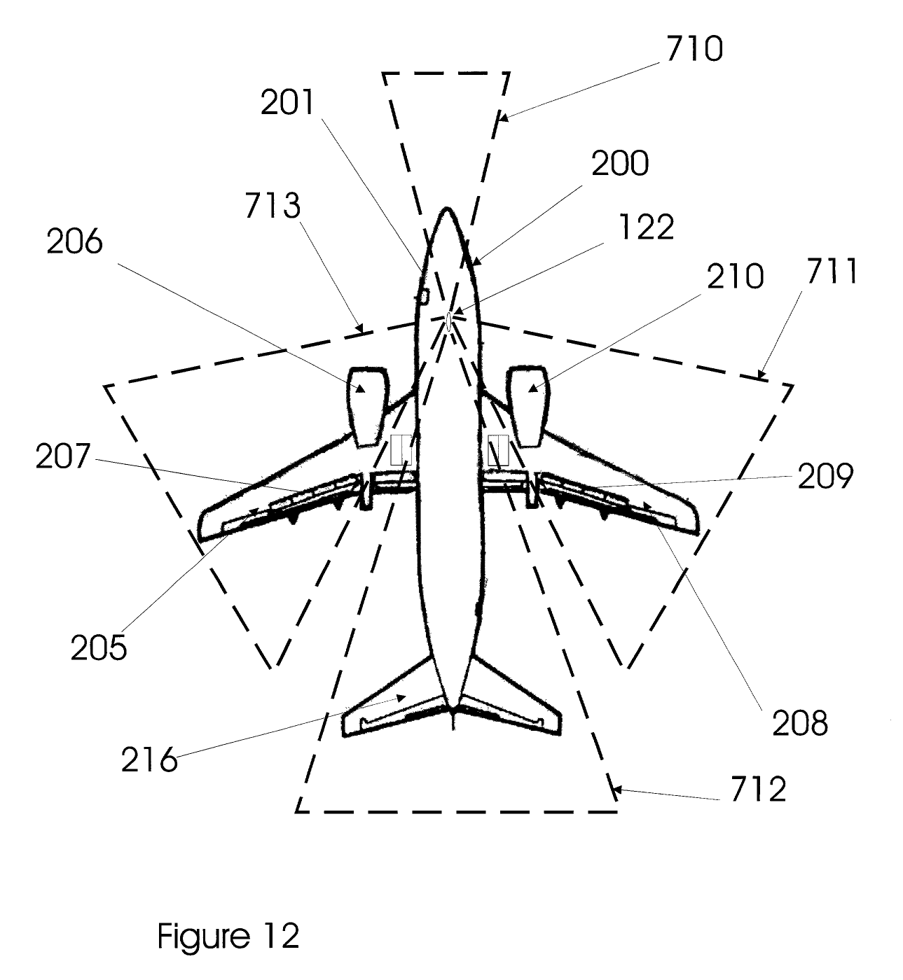

FIG. 12 shows a bottom view of a 737 aircraft 200 along with the areas within the view of the bottom camera array 122. The forward camera 301 in the bottom camera array 122 covers the viewing area within the dashed triangle 710. The third camera 303 in the bottom camera array 122 covers the area within the dashed triangle 713. This viewing area includes the majority of the wing 205 and engine 206. The fourth camera 304 covers the viewing area within section 711, which includes wing 208 and engine 210. The final camera 305 in the bottom camera array 122 covers the tail section 712. Note that the second camera 302 in the bottom array 122 points straight down at the earth.

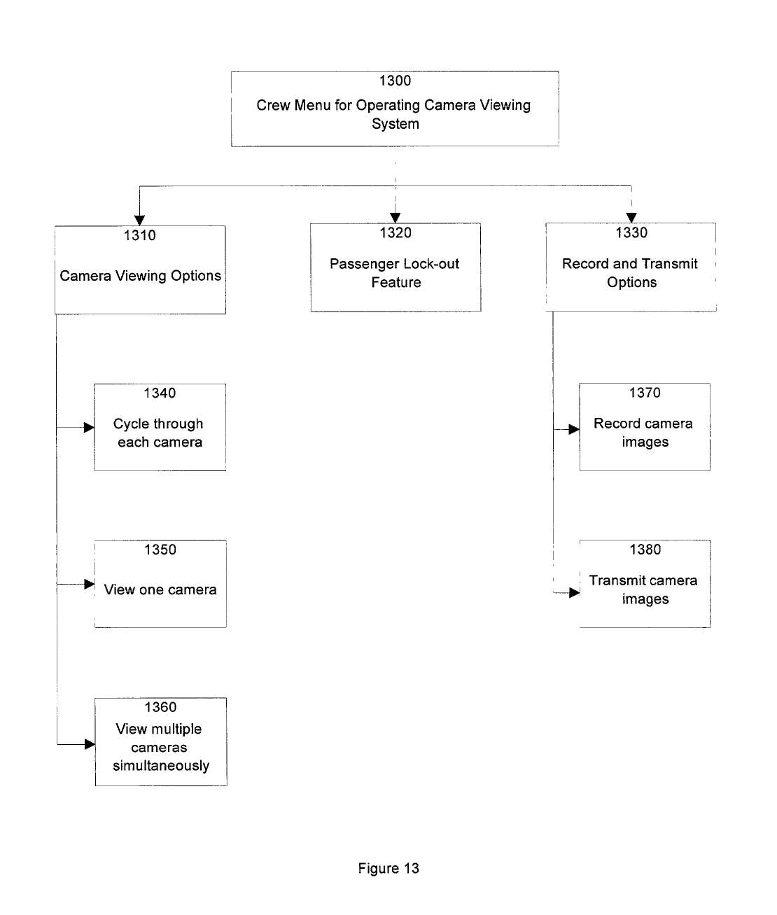

FIG. 13 shows the menu 1300 available to the crew of the aircraft 200 for operating the camera viewing system 100. In a preferred embodiment, the crew access the menu 1300 through a touch screen LCD display. The menu 1300 that controls the camera system 100 has three primary choices. The first choice 1310 is a camera viewing choice. Under this menu section 1310, the crew can select the manner in which they wish to view the images collected by the camera system 100. In choice 1340, the crew can have the computer system 110 cycle through showing each camera at a preset time interval. For instance, the crew would see the image from camera 301 for 20 seconds, then the image from camera 302 for 20 seconds, then the image from camera 303 for 20 seconds, and so on. The duration of this preset time interval could be adjusted by the aircraft crew. Alternatively, in choice 1350, the crew can select to view one of the cameras for an indefinite period. Choice 1350 anticipates that one of the cameras of the camera system 120 will view some sort of damage to the aircraft 200 and that the crew will want to continuously monitor that damage with the appropriate camera. In choice 1360, the crew can select multiple cameras to view simultaneously. Several of the cameras in the various camera arrays have overlapping fields of vision. It is possible that certain damage to the aircraft will be visible to several cameras. Under choice 1360, the crew can instruct computer 110 to show the views seen by some or all of the cameras that have views of the damage continuously.

In FIG. 13, choice 1320 is the passenger lock-out feature. In the event of damage to the aircraft 200, the passengers could see the damage to the aircraft 200 through the camera system 100 thereby causing panic. To prevent the passengers from panicking at the sight of the damaged aircraft 200, the crew could “lock-out” and prevent the passengers from viewing the camera system 100 on their LCD displays 900 by accessing choice 1320.

Referring again to FIG. 13, the crew can instruct the computer 110 to record a specific camera view and transmit it using choice 1330. In the event that there is damage to the aircraft 200, the crew may wish to record the camera angle covering the damage for maintenance purposes using choice 1370. This recording would then be included with the flight information in the aircraft's “black box.” However, in the event of damage, it is possible that the crew could benefit from advice from engineers and pilots on the ground. Therefore, under choice 1380, the crew can transmit images showing the state of their aircraft to experts on the ground.

The menu system 1400 available to passengers for operating the camera system 100 is shown in FIG. 14. This menu system 1400 is accessible to passengers through their touch screen displays 900. There are two primary choices available to passengers, 1410 and 1420. Choice 1410 allows passengers to select which camera angle they want to see on their display 900. In this menu selection, the passengers first chose which camera array they want to see, choice 1460 gives the top array 121, choice 1470 gives bottom array 122, or choice 1450 gives side array 123. After making that choice, the passengers then select the specific camera they wish to see. The reference numbers of the cameras, 123A, 123B, 401, 402, 301, 302, 303, 304, and 305 are the available choices. Choice 1451 gives the view from camera 123A, choice 1452 gives the view from camera 123B, choice 1461 gives the view from camera 401, choice 1462 gives the view from camera 402, choice 1471 gives the view from camera 301, choice 1472 gives the view from camera 302, choice 1473 gives the view from camera 303, choice 1474 gives the view from camera 304, and choice 1475 gives the view from camera 305. The passengers can then access choice 1420 that allows passengers to choice between hearing a prerecorded musical section with choice 1430 or hearing an education recording that follows the flight path with choice 1440. The music and educational recording may be prerecorded on storage media such as magnetic tape, including popular 8 mm or 4 mm cassettes, on CD-ROM optical disks, or on DVD-ROM optical disks.

While the invention has been shown and described with reference to a particular embodiment thereof, it will be understood to those skilled in the art, that various changes in form and details may be made therein without departing from the spirit and scope of the invention.

I claim:

1. An airplane camera system comprised of:
a top camera array;
a bottom camera array;
a side camera array;
a computer;
a passenger viewing display; and
a pilot display, said top camera array, said bottom camera array, said side camera array, said passenger viewing display, and said pilot display are connected to said computer, whereby a plurality of images gathered by said top camera array, said bottom camera array, and said side camera array are processed by said computer and at least one of said images is displayed on said passenger viewing display and said pilot display.

2. The airplane camera system as described in claim 1, wherein said top camera array is comprised of:
a digital camera; and
an aerodynamic transparent durable housing, said digital camera is contained within said aerodynamic transparent durable housing.

3. The airplane camera system as described in claim 2, wherein said bottom camera array is comprised of:
a digital camera; and
an aerodynamic transparent durable housing, said digital camera is contained within said aerodynamic transparent durable housing.

4. The airplane camera system as described in claim 3, wherein said top camera array, said bottom camera array, and said side camera array are connected to said computer via fiber-optic cable.

5. The airplane camera system as described in claim 4, wherein said passenger viewing display, and said pilot display are connected to said computer via fiber-optic cable.

6. The airplane camera system as described in claim 5, wherein said passenger viewing display is a liquid crystal display mounted in a back portion of a passenger seat.

7. The airplane camera system as described in claim 6, wherein said passenger viewing display is a touch-screen display.

8. An airplane camera system comprised of:
a top camera array mounted to a top surface of an aircraft fuselage, said top camera array is comprised of:
a digital camera; and
an aerodynamic transparent housing, said digital camera is mounted within said aerodynamic transparent housing, said aerodynamic transparent housing is mounted to said aircraft fuselage;
a bottom camera array mounted to a bottom surface of an aircraft fuselage, said bottom camera array is comprised of:
a digital camera; and
an aerodynamic transparent housing, said digital camera is mounted within said aerodynamic transparent housing, said aerodynamic transparent housing is mounted to said aircraft fuselage;
a passenger viewing display;
a pilot display; and
a computer, said digital camera mounted in said top camera array, said digital camera mounted in said bottom camera array, said passenger viewing display, and said pilot display are connected to said computer, whereby images gathered by said digital camera mounted in said top camera array and said digital camera mounted in said bottom camera array are processed by said computer and at least one said image is displayed on said passenger viewing display and said pilot display.

9. The airplane camera system recited in claim 8, wherein said digital camera included in said top camera array points to the rear of said aircraft fuselage thereby viewing a tail and rear stabilizer.

10. The airplane camera system recited in claim 9, wherein said top camera array includes an additional digital camera pointed toward a front portion of said aircraft fuselage.

11. The airplane camera system recited in claim 10, wherein said digital camera included in said bottom camera array is pointed downward thereby viewing a surface below said aircraft fuselage.

12. The airplane camera system recited in claim 11, wherein said bottom camera array includes an additional digital camera pointed toward a starboard wing and port engine.

13. The airplane camera system recited in claim 12, wherein said bottom camera array includes an additional digital camera pointed toward a port wing and port engine.

14. The airplane camera system recited in claim 13, wherein both digital cameras mounted in said top camera array and all three digital cameras mounted in said bottom camera array are connected to said computer by a fiber-optic cable.

15. The airplane camera system recited in claim 14, wherein said passenger viewing display and said pilot display are connected to said computer by a fiber-optic cable.

16. A process for showing images to a pilot and a passenger on an aircraft, comprising the steps of:
acquiring a series of images with a plurality of digital cameras;
transmitting said series of images to a computer;
processing said series of images for viewing;
selecting a specific digital camera for viewing;
transmitting an image from among said series of images that was acquired from said specific digital camera to a pilot display and a passenger viewing display; and
displaying said image on said pilot display and said passenger display.

17. The process recited in claim 16, further comprising the step of selecting an audio recording to accompany the display of said image.

18. The process recited in claim 17, further comprising the step of blocking the transmission of said image to said passenger viewing display.
